(19) United States
(12) Patent Application Publication
(10) Pub. No.: US 2011/0236822 A1
(43) Pub. Date: Sep. 29, 2011

(54) METHOD OF TREATING SEASONED DEVELOPER SOLUTION

(76) Inventors: Livia T. Memetea, Wayne, IL (US); William F. Smith, Brockport, NY (US)

(21) Appl. No.: 12/731,182

(22) Filed: Mar. 25, 2010

(51) Int. Cl. G03G 9/12

(52) U.S. Cl. 430/137.22

(57) ABSTRACT

Seasoned lithographic printing plate developer solutions are treated with a hypochlorite to decompose infrared radiation-sensitive cyanine dyes that are released from lithographic elements during alkaline development. The hypochlorite is useful to decompose both suspended and soluble forms of the cyanine dyes so they can be more safely discharged to the environment in the seasoned developer solution. This treatment avoids expensive filtration equipment and incineration for handling seasoned developer solutions before they are discharged to the environment.

### FIELD OF THE INVENTION

This invention relates to a method for decomposing or degrading infrared radiation-sensitive cyanine dyes in seasoned developer solutions so the developer solutions can be more safely discharged to the environment.

### BACKGROUND OF THE INVENTION

Radiation-sensitive compositions are routinely used in the preparation of imageable materials including lithographic printing plate precursors. Such compositions generally include a radiation-sensitive component, an initiator system, and a binder, each of which has been the focus of research to provide various improvements in physical properties, imaging performance, and image characteristics. Such compositions are generally provided as imageable layers.

Recent developments in the field of printing plate precursors concern the use of radiation-sensitive compositions that can be imaged by means of lasers or laser diodes. Laser exposure does not require conventional silver halide graphic arts films as intermediate information carriers (or “masks”) since the lasers can be controlled directly by computers. High-performance lasers or laser-diodes that are used in commercially-available image-setters generally emit radiation having a wavelength of at least 700 nm, and thus the radiation-sensitive compositions are required to be sensitive in the near-infrared or infrared region of the electromagnetic spectrum. Common radiation-sensitive components include infrared radiation-sensitive dyes that are used to absorb heat from laser imaging and facilitate appropriate reactions for image formation.

There are two possible ways of using radiation-sensitive compositions for the preparation of printing plates. For negative-working printing plates, exposed regions in the radiation-sensitive compositions are hardened and unexposed regions containing photopolymer and infrared radiation-sensitive dyes are washed off during development. For positive-working printing plates, the exposed regions are dissolved in a developer and the unexposed regions become an image. The removed regions can also include infrared radiation-sensitive dyes.

Imaged lithographic printing plates are typically developed or processed using a developer solution to remove either non-imaged (negative-working) or imaged (positive-working) regions in the imaged element. The processing apparatus also usually includes rollers and brushes to facilitate removal of element materials that generally include various polymeric materials such as organic solvents, surfactants, unreacted photopolymers or ethylenically unsaturated polymerizable monomers, as well as infrared radiation-sensitive dyes (such as cyanine dyes). The developer solution is expected to function in a processor for a specific time (“cycle”) to “develop” a designated volume or “area” of imaged elements or to remove a certain amount of element area before it is discarded. The number of square meters of elements per liter of developer characterizes a “cycle”. Normally, the surface area of imaged elements processed in a cycle would be 10-20 m²/liter of developer solution, but this value varies according to type of element, type of processor, and the composition of the developer solution. For example, if the coating weight of the imaged element is about 1.8 g/m², and the concentration of the IR-sensitive dye in the element is 5 weight %, the seasoned developer solution could have a concentration of IR-sensitive dye of from 0.9 to 1.8 g/l at the end of a typical cycle before the solution is to be discarded.

As the developer solution is used to process more imaged elements, it becomes more contaminated (or “seasoned”) with removed components. As the developer solution becomes more seasoned, it must be treated in some manner before disposal since it contains chemicals, such as the IR-sensitive dyes, that should be removed before the solution is discharged to the environment.

Usually, the IR dyes in seasoned developer solutions are present in two forms: either suspended as microparticles or dissolved in an amount corresponding to its solubility limit. The dissolved IR dye can be an immediate threat to aquatic life if discharged into the environment. Moreover, the suspended IR dye can be dissolved once in contact with underground water and further harm the environment.

The literature describes a number of methods for treating “waste” or seasoned developer solutions including the use of expensive filtration centrifugation as described in WO 93/07539 (Danon et al.) to remove predominantly solid wastes such as photopolymers. This publication describes the problems associated with centrifugation and filtration techniques because they require complicated equipment and procedures. There is no suggestion about the removal or degradation of infrared radiation-sensitive dyes.

An oxidant can be added to photoengraving waste solution containing photopolymers to form a precipitate that can be removed according to JP Kokai (Patent Application Publication) 1977(52)-030773 (Masamitsu et al.).

Other treatment procedures for printing plate waste solutions are described in JP Kokai 2002-233860 (Yoko), 2004-070031 (Yoshifumi et al.), and 2008-080229 (Toni et al.).

There is a need, however, for a simple and inexpensive means for removing or “neutralizing” infrared radiation-sensitive dyes that are found in seasoned developer solutions so the solutions can be more safely discarded to the environment.

### SUMMARY OF THE INVENTION

This invention provides a method of treating a seasoned developer solution by adding a composition containing a hypochlorite to the seasoned developer solution that contains one or more infrared radiation-sensitive cyanine dyes to decompose the cyanine dyes.

We have found that this method is useful for treating waste or seasoned developer solutions used to process imaged negative-working lithographic printing plate precursors. These imaged precursors are generally processed in neutral or alkaline developer solutions to remove non-exposed materials of the imageable layer including unreacted photopolymers, monomers, initiators, and infrared radiation-sensitive dyes.

An advantage is that the infrared radiation-sensitive dye in the seasoned developer solution is decomposed or degraded to a significant extent so that the waste solution is less toxic and can be discharged to the environment in a safe manner. The dye, in both colloidal microparticulate and soluble forms, is decomposed, degraded, or removed from the developer solution in a quantitative manner, that is, in an amount of at least up to 99 weight % and possibly up to 99.99 weight % as determined using liquid chromatography-mass spectrometry analysis. The treatment method of this invention produces very little precipitate that remains in the seasoned developer, and it thus does not require filtration or other expensive or complicated mechanical removing apparatus (pumps and filters). The, the present invention is a simple and inexpensive method.

Moreover, by treating the IR dyes, the method of this invention does not introduce secondary pollutants into the seasoned developer solution. As noted above, the present invention can be used to treat developer solutions containing suspended (or colloidal) IR dyes, water-soluble IR dyes, or both types of dyes that are present in the same solution.

These advantages are achieved by using the minimum amount of hypochlorite to react with the infrared radiation-sensitive dyes in the seasoned developer solution. According to this invention, by using vigorous stirring during treatment to expose the IR dyes to oxidation and to prevent their inclusion in the degradation products or the co-precipitation of the IR dyes with the degradation products, a minimum amount of hypochlorite is needed. The hypochlorite-treated developer solution will contain minimal colloidal degradation products of the IR-sensitive dyes that can be discharged to the environment such as a municipal sewer without concern for toxicity. The present invention produces a minimal amount of degradation products in insoluble form that may require up to 7 days for settling. Thus, expensive filtration equipment and incineration are avoided.

It is important that a user of the present invention take some routine effort to “match” the amount of hypochlorite to be added to the seasoned developer solution to the amount of IR dye(s) that is likely to be in that solution. This effort will minimize the amount of IR dye that would not be degraded. It will also minimize the amount of hypochlorite that is discharged to the sewer. It is highly desirable to highly agitate (up to 20,000 rpm) the seasoned developer solution during addition of the hypochlorite to help with IR dye oxidation. Further it is also desirable that the seasoned developer solution is diluted at least 1 time and more likely, at least 5 times. This combination of features (agitation and dilution) will help avoid the inclusion of IR dyes in the precipitated degradation product, but excluding the possibility that some IR dye will not be degraded.

### DETAILED DESCRIPTION OF THE INVENTION

The present invention can be used to “treat” any seasoned developer solution that is used to process or develop imaged elements containing an infrared radiation-sensitive cyanine dye. Such elements can be either negative-working or positive-working lithographic printing plate precursors that are imaged and developed to provide lithographic printing plates. The invention is particularly useful for treating seasoned developer solutions used to develop precursors that are imaged using thermal imaging means such as IR lasers. However, the method of this invention is most useful for treating seasoned developer solutions that have been used to process negative-working imageable elements that contain non-reacted or non-crosslinked photopolymer compositions containing non-reacted or non-crosslinked free radical polymerizable or crosslinkable compounds such as ethylenically unsaturated polymerizable or crosslinkable compounds that are known in the art, or non-reactive polymeric binders. Seasoned developer solutions used to process positive-working lithographic printing plate precursors can generally include one or more non-reactive polymeric binders and developability inhibitors.

Unless otherwise indicated, the terms “processing solution”, “developer”, and “developer solution” mean the same thing, that is, they are used to reference solutions used to process or develop imaged lithographic printing plate precursors. Also, unless otherwise indicated, the terms “seasoned processing solution”, “seasoned developer”, and “seasoned developer solution” mean the same thing, that is, they are used to reference developer solutions that contain some “contaminants” or materials removed from the imaged precursors.

The following representative references describe imageable elements that can contain IR-sensitive cyanine dyes that can be developed with developer solutions that become seasoned, which developer solutions can be treated according to the present invention. This list of publications is not meant to be exhaustive.

Positive-Working Imageable Elements:

“Single-layer” and multi-layer positive-working imageable elements are described for example, in WO 2004/081662 (Memetea et al.), U.S. Pat. Nos. 6,255,033 (Levanon et al.), 6,280,899 (Hoare et al.), 6,294,311 (Shimazu et al.), 6,352,812 (Shimazu et al.), 6,593,055 (Shimazu et al.), 6,352,811 (Patel et al.), 6,358,669 (Savariar-Hauck et al.), 6,528,228 (Savariar-Hauck et al.), 6,485,890 (Hoare et al.), 6,558,869 (Hearson et al.), 6,706,466 (Parsons et al.), 6,541,181 (Levanon et al.), 7,223,506 (Kitson et al.), 7,229,744 (Patel), 7,241,556 (Saraiya et al.), 7,247,418 (Saraiya et al.), 7,270,930 (Hauck et al.), 7,279,263 (Goodin et al.), 7,291,440 (Ray et al.), 7,300,726 (Patel et al.), 7,338,745 (Ray et al.), 7,399,576 (Levanon), 7,544,462 (Levanon et al.), 7,563,556 (Savariar-Hauck et al.), and 7,582,407 (Savariar-Hauck et al.), EP 1,627,732 (Hatanaka et al.), and U.S. Published Patent Applications 2004/0067432 A1 (Kitson et al.) and 2005/0037280 (Loccufier et al.), 2005/0214677 (Nagashima), 2004/0013965 (Memetea et al.), 2005/0003296 (Memetea et al.), and 2005/0214678 (Nagashima).

Negative-Working Imageable Elements:

Negative-working imageable elements are described for example, in EP Patent Publications 770,494A1 (Vermeersch et al.), 924,570A1 (Fujimaki et al.), 1,063,103A1 (Uesugi), EP 1,182,033A1 (Fujimako et al.), EP 1,342,568A1 (Vermeersch et al.), EP 1,449,650A1 (Goto), and EP 1,614,539A1 (Vermeersch et al.), U.S. Pat. Nos. 4,511,645 (Koike et al.), 6,027,857 (Teng), 6,309,792 (Hauck et al.), 6,569,603 (Furukawa et al.), 6,899,994 (Huang et al.), 7,045,271 (Tao et al.), 7,049,046 (Tao et al.), 7,261,998 (Hayashi et al.), 7,279,255 (Tao et al.), 7,285,372 (Baumann et al.), 7,291,438 (Sakurai et al.), 7,326,521 (Tao et al.), 7,332,253 (Tao et al.), 7,442,486 (Baumann et al.), 7,452,638 (Yu et al.), 7,524,614 (Tao et al.), 7,560,221 (Timpe et al.), 7,574,959 (Baumann et al.), 7,615,323 (Shrehmel et al.), and 7,672,241 (Munnelly et al.), and U.S. Patent Application Publications 2003/0064318 (Huang et al.), 2004/0265736 (Aoshima et al.), 2005/0266349 (Van Damme et al.), and 2006/0019200 (Vermeersch et al.). Other negative-working compositions and elements are described for example in Japanese Kokai 2000-187322 (Takasaki), 2001-330946 (Saito et al.), 2002-040631 (Sakurai et al.), 2002-341536 (Miyamoto et al.), and 2006-317716 (Hayashi).

The processed elements and the resulting seasoned developer solutions generally include one or more IR-sensitive cyanine dyes of which there are hundreds described in the lithographic art and include but are not limited to, infrared radiation absorbing cyanine compounds, chromophores, or sensitizers that absorb imaging radiation, or sensitize a composition to imaging infrared radiation having a λₘₐₓ of from about 700 nm and up to and including 1400 nm, and typically from about 700 to about 1200 nm.

Useful IR radiation absorbing chromophores include various IR-sensitive dyes (“IR dyes”). Examples of suitable cyanine IR dyes comprising the desired chromophore include but are not limited to, cyanine dyes, merocyanine dyes, phthalocyanine dyes, indocyanine dyes, indotricarbocyanine dyes, oxatricarbocyanine dyes, thiocyanine dyes, thiatricarbocyanine dyes, merocyanine dyes, cryptocyanine dyes, naphthalocyanine dyes, and any substituted or ionic (cationic or anionic) form of these dye classes. Suitable dyes are also described in U.S. Pat. Nos. 5,208,135 (Patel et al.), 6,153,356 (Urano et al.), 6,264,920 (Achilefu et al.), 6,309,792 (Hauck et al.), 6,569,603 (noted above), 6,787,281 (Tao et al.), 7,135,271 (Kawaushi et al.), and EP 1,182,033A2 (noted above). Infrared radiation absorbing N-alkylsulfate cyanine dyes are described for example in U.S. Pat. No. 7,018,775 (Tao). A general description of a class of suitable cyanine dyes is shown by the formula in paragraph [0026] of WO 2004/101280 (Munnelly et al.).

In addition to low molecular weight IR-absorbing dyes, cyanine IR dye chromophores bonded to polymers can be present as well. Moreover, cyanine IR dye cations can present as well, that is, the cation is the IR absorbing portion of the dye salt that ionically interacts with a polymer comprising carboxy, sulfo, phospho, or phosphono groups in the side chains.

Near infrared absorbing cyanine dyes are also useful in the imageable elements and are described for example in U.S. Pat. Nos. 6,309,792 (noted above), 6,264,920 (Achilefu et al.), 6,153,356 (noted above), 5,496,903 (Watanabe et al.). Suitable dyes can be obtained from various commercial sources including American Dye Source (Baie D'Urfe, Quebec, Canada) and FEW Chemicals (Germany).

The infrared radiation-sensitive cyanine dyes that end up in the seasoned developer solutions are completely soluble or they are present as colloidal (microparticulate) suspensions that have a water solubility of at least 0.001% at 25° C. Cyanine dyes that are often present in seasoned developer solutions can have either anionic or cationic chromophores.

For example, the seasoned developer solution can contain one or more of the following common cyanine IR dyes:

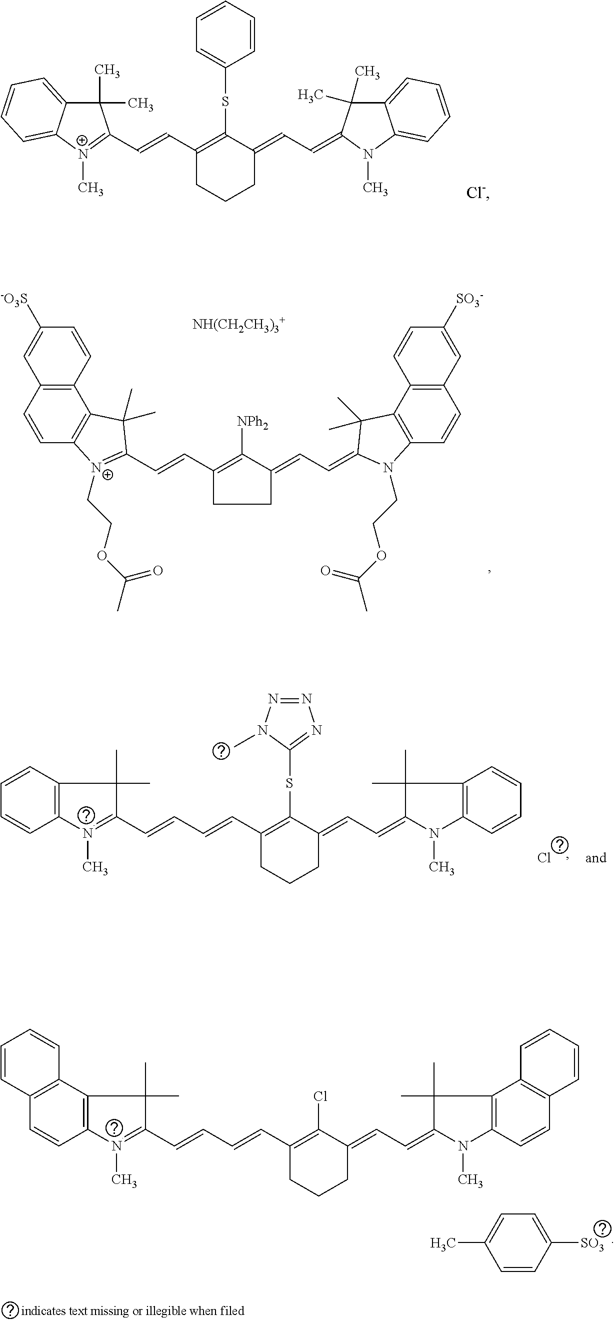

After thermal imaging, the imaged elements are generally processed “off-press” using a developer solution having a pH of from about 4 to about 14, or typically from about 6 to about 13.5. Processing is carried out for a time sufficient to remove predominantly only the non-exposed regions (for negative-working printing plate precursors) or only the exposed regions (for positive-working printing plate precursors) of the imaged layer(s) to reveal the hydrophilic surface of the substrate. The revealed hydrophilic surface repels ink while the oleophilic regions accept ink.

The seasoned developer solutions can also include one or more nonionic or anionic surfactants, alkalinity agents (such as hydroxides, silicates, metasilicates, and amines), antifoaming agents, anti-corrosion agents, biocides, and other compounds known in the art for preparing developer solutions. Some seasoned developer solutions can also include one or more water-miscible organic solvents (such as benzyl alcohol) in an amount of up to 15 weight %.

The imaged element is contacted with a developer solution in an appropriate manner. For example, development can be accomplished using what is known as “manual” development, “dip” development, or processing with an automatic development apparatus (processor). In the case of “manual” development, the entire imaged lithographic element is rubbed with a sponge or cotton pad impregnated with a suitable developer, followed by rinsing with water. “Dip” development involves dipping the imaged element in a tank or tray containing the appropriate developer for about 10 to about 60 seconds under agitation, followed by rinsing with water with or without rubbing with a sponge or cotton pad. The use of automatic development apparatus is well known and generally includes pumping a developer into a developing tank or ejecting it from spray nozzles. The apparatus may also include a suitable rubbing mechanism (for example a brush or roller) and a suitable number of conveyance rollers. Some developing apparatus include lasers for imaging and the apparatus is divided into an imaging section and a developing section.

The developer solution also can be applied to the imaged element by rubbing, spraying, jetting, dipping, immersing, slot die coating (for example see FIGS. 1 and 2 of U.S. Pat. No. 6,478,483 of Maruyama et al.) or reverse roll coating (as described in FIG. 4 of U.S. Pat. No. 5,887,214 of Kurui et al.), or by wiping the outer layer with the developer solution or contacting it with a roller, impregnated pad, or applicator containing the gum. For example, the imaged element can be brushed with the developer solution, or it can be poured onto it or applied by spraying the imaged surface with sufficient force using a spray nozzle system as described for example in [0124] of EP 1,788,431A2 (noted above) and U.S. Pat. No. 6,992,688 (Shimazu et al.). Still again, the imaged element can be immersed in the developer solution and rubbed by hand or with an apparatus.

The developer solution can also be applied in a processing unit (or station) in a suitable apparatus that has at least one roller for rubbing or brushing the imaged element while the developer solution is applied. Residual developer solution may be removed (for example, using a squeegee or nip rollers) or left on the resulting printing plate without any rinsing step. Excess developer solution can be collected in a tank and used several times, and replenished if necessary from a reservoir. The developer solution “replenisher” can be of the same concentration as that used in processing, or be provided in concentrated form and diluted with water at an appropriate time.

Some useful developer solutions and methods for their use are described for example, in U.S. Pat. Nos. 7,507,526 (Miller et al.) and 7,316,894 (Miller et al.). Both aqueous alkaline developers and organic solvent-containing developers can be used. Developer solutions commonly include surfactants, chelating agents (such as salts of ethylenediaminetetraacetic acid), organic solvents (such as benzyl alcohol), and alkaline components (such as inorganic metasilicates, organic metasilicates, hydroxides, and bicarbonates).

Useful alkaline aqueous developer solutions include 3000 Developer, 9000 Developer, GOLDSTAR Developer, GREENSTAR Developer, ThermalPro Developer, PROTHERM Developer, MX1813 Developer, and MX1710 Developer (all available from Eastman Kodak Company). These compositions also generally include surfactants, chelating agents (such as salts of ethylenediaminetetraacetic acid), and alkaline components (such as inorganic metasilicates, organic metasilicates, hydroxides, and bicarbonates).

Organic solvent-containing developer solutions are generally single-phase solutions of one or more organic solvents that are miscible with water. Useful organic solvents include the reaction products of phenol with ethylene oxide and propylene oxide [such as ethylene glycol phenyl ether (phenoxyethanol)], benzyl alcohol, esters of ethylene glycol and of propylene glycol with acids having 6 or less carbon atoms, and ethers of ethylene glycol, diethylene glycol, and of propylene glycol with alkyl groups having 6 or less carbon atoms, such as 2-ethylethanol and 2-butoxyethanol. The organic solvent(s) is generally present in an amount of from about 0.5 and up to 15% based on total developer solution weight. The organic solvent-containing developer solutions can be neutral, alkaline, or slightly acidic in pH.

Representative solvent-containing developer solutions include ND-1 Developer, Developer 980, Developer 1080, 2 in 1 Developer, 955 Developer, D29 Developer (described below), and 956 Developer (all available from Eastman Kodak Company).

In some instances, a developer solution is used to both develop the imaged element by removing predominantly the non-exposed regions and also to provide a protective layer or coating over the entire imaged and developed surface. In this aspect, the processing solution can behave somewhat like a gum that is capable of protecting the lithographic image on the printing plate against contamination or damage (for example, from oxidation, fingerprints, dust, or scratches). Such developer solutions are described for example in U.S. Patent Application Publication 2009/0263746 (Ray et al.). Such “low-pH” developer solutions generally have a pH greater than 2 and up to about 11, and typically from about 6 to about 11 as adjusted using a suitable amount of an acid or base. They generally include one or more anionic surfactants, even though optional components (such as nonionic surfactants) can be present if desired. Useful anionic surfactants include those with carboxylic acid, sulfonic acid, or phosphonic acid groups (or salts thereof).

In carrying out the present invention, a hypochlorite is added to the seasoned developer solution containing one or more infrared radiation-sensitive cyanine dyes to decompose the cyanine dye(s). The hypochlorite is added to the seasoned developer solution prior to its discharge to the environment or waste stream.

The seasoned developer solution can be diluted 1 to 20 times (for example, 5 to 10 times) with water before addition of the hypochlorite composition.

In general, the hypochlorite composition is added to the seasoned developer solution in a continuous fashion, or in portions until the seasoned developer solution becomes colorless, usually at room temperature and often with agitation. For example, the hypochlorite composition can be added to the seasoned developer solution in a drop wise or metered fashion.

As used herein, the term “hypochlorite” is intended to mean both hypochloric acid and salts of hypochloric acid such as alkali metal hypochlorites (such as sodium hypochlorite, potassium hypochlorite, and lithium hypochlorite) and ammonium hypochlorite. While hypochloric acid can be added to the seasoned developer solution, it quickly forms salts, so it is more convenient to add the appropriate salt in the practice of the invention. Multiple hypochlorites can be added (for example, both sodium and potassium hypochlorite, or sodium hypochlorite with hypochloric acid).

The amount of hypochlorite in the hypochlorite solution is at least 0.1 weight % and up to 20 weight %, from 0.1 to 13 weight %, or from 0.1 to 6 weight %. The amount to be added can be readily determined by a skilled worker because it is best to add sufficient hypochlorite to match or be close to the suspected amount of IR dyes in the seasoned developer solution, with perhaps up to 10% excess compared the suspected IR dye concentration. This may take some routine experimentation that a skilled worker could readily perform to optimize the practice of this invention with any given seasoned developer solution.

In addition, the seasoned developer solution can be agitated during addition of the hypochlorite at a shear rate of at least 10 rpm and up to 20,000 rpm. More typically, a high shear rate of at least 2,000 rpm is used, and the optimum shear rate may be up to 6,000 rpm. These conditions of addition inhibit the precipitation of the IR-sensitive cyanine dye before it is degraded by the hypochlorite.

The present invention provides at least the following embodiments and combinations thereof:

1. A method of treating a seasoned developer solution comprising adding a composition containing a hypochlorite to the seasoned developer solution that contains one or more infrared radiation-sensitive cyanine dyes to decompose the one or more cyanine dyes.

2. The method of embodiment 1 wherein the hypochlorite is added to the seasoned developer solution before the solution is discharged to the environment.

3. The method of embodiment 1 or 2 wherein the seasoned developer solution is diluted at least 5 times before addition of the hypochlorite composition.

4. The method of any of embodiments 1 to 3 wherein the hypochlorite composition is added to the seasoned developer solution in portions until the seasoned developer solution becomes colorless.

5. The method of any of embodiments 1 or 4 wherein the hypochlorite composition is added to the seasoned developer solution in a dropwise fashion.

6. The method of any of embodiments 1 to 5 wherein the hypochlorite is sodium hypochlorite or potassium hypochlorite, or both.

7. The method of any of embodiments 1 to 6 wherein the seasoned developer solution is agitated during addition of the hypochlorite at a shear rate of from 10 to 20,000 rpm.

8. The method of any of embodiments 1 to 7 wherein the infrared radiation-sensitive cyanine dye is in suspended form, or has a water solubility of at least 0.001% at 25° C.

9. The method of any of embodiments 1 to 8 wherein the seasoned developer solution also contains one or more unreacted free radical polymerizable, crosslinkable compounds, or non-reactive polymeric binders.

10. The method of any of embodiments 1 to 9 wherein the infrared radiation-sensitive cyanine dye is a cationic or anionic cyanine dye.

11. The method of any of embodiments 1 to 10 wherein the seasoned developer solution contains one or more of the following cyanine dyes:

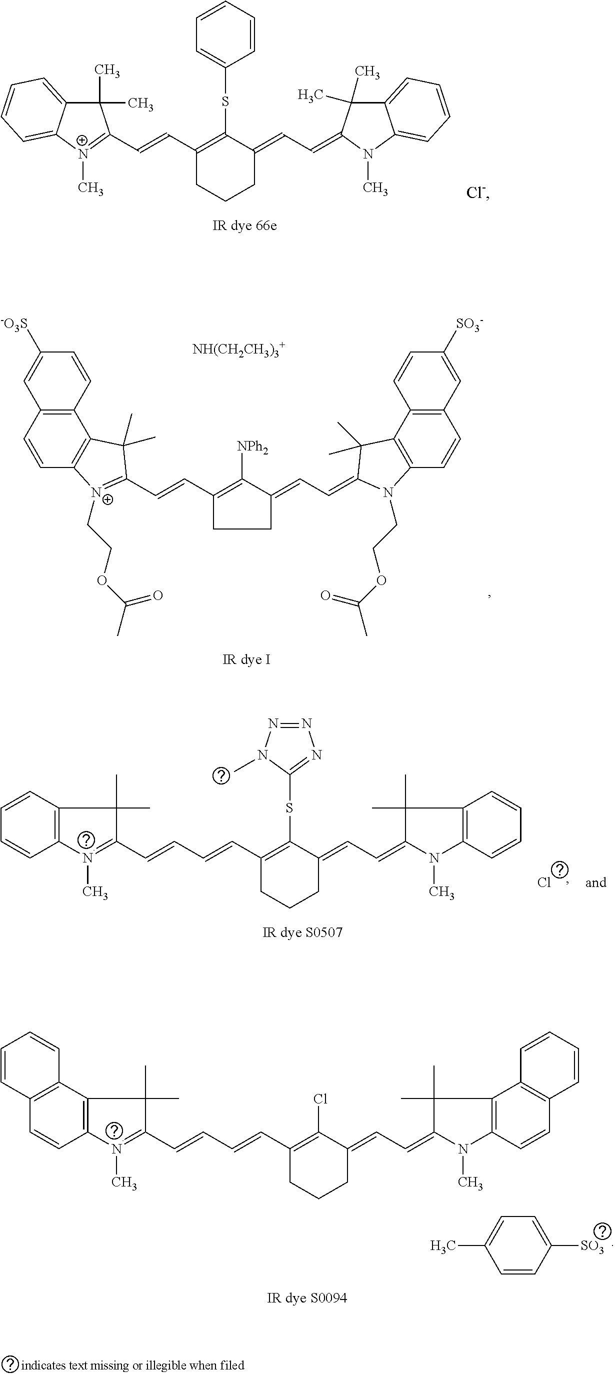

12. The method of any of embodiments 1 to 11 wherein the seasoned developer solution has a pH of at least 6 and up to and including 13.5.

13. The method of any of embodiments 1 to 12 wherein the seasoned developer solution contains up to 15 weight % of a water-miscible organic solvent.

14. The method of any of embodiments 1 to 13 wherein the hypochlorite composition is added to the seasoned developer solution at room temperature with agitation.

15. The method of any of embodiments 1 to 8 and 10 to 14 wherein the seasoned developer solution contains one or more non-reactive polymeric binders.

The following Examples are provided to illustrate the practice of the invention but not to limit it in any manner.

### Comparative Example 1

A variety of compounds were used in an attempt to precipitate the anionic chromophore of an IR dye as insoluble salts for filtration or incineration.

IR Dye I described above was dissolved at a 0.3% level in methanol. A portion of the solution was treated with a 3% solution of each of the following compounds in water: calcium nitrate, calcium lactate, barium chloride, benzyl trimethyl ammonium chloride, benzyl stearyl dimethyl ammonium chloride, quaternized polyimidazoline oligomer, poly(diallyl dimethyl ammonium) chloride, poly(vinyl benzyl trimethyl ammonium) chloride, poly(p-xylene tetrahydrothiophenium) chloride, and poly(acrylamide-co-diallyl dimethylammonium) chloride. None of these compounds precipitated IR Dye I.

### Comparative Example 2

We attempted to precipitate the cationic chromophore of an IR dye as insoluble salts for filtration and incineration. IR dye 66e (cationic) was dissolved at a 0.3% level in methanol. An aliquot of the solution was treated with aqueous solutions of the following organic acids at 3% concentration: naphthalene sulfonic acid, poly(vinyl phosphonic), poly(styrene sulfonic), poly(vinyl sulfonic), poly(vinyl alcohol-vinyl acetate-co-itaconic acid). None of these organic acids were useful to precipitate the IR dye 66e.

### Comparative Example 3

In this example, an IR dye was treated with oxidative and reducing reagents (TABLE I) in at attempt to degrade the IR dye. A 0.3% solution of the IR dye 66e in methanol was used in each test with the exception that with N-bromo-succinimide, the dye was dissolved in acetone. In most cases, the green color of the dye solution turned a light pink. In one case, a light pink precipitate was formed. The pink degradation product was isolated by evaporation and dissolved in a few drops of methanol. This solution was then spotted on a sodium chloride disk, evaporated under an IR lamp, and the Fournier Transform IR (FTIR) spectrum was taken. Precipitate 12 (TABLE I below) was filtered, dried and mixed in potassium bromide from which an IR disk was prepared. The pink degradation products had spectra completely different from IR dye 66e and showed an advanced degradation stage.

The brown degradation products had spectra that were also different from IR dye 66e but showed an intermediate degradation stage consistent with the dye molecule being broken in chromophore fragments that were further identified by liquid chromatography-mass spectrometry (LC-MS). The black degradation products were not analyzed.

While reagents shown in TABLE I may be useful to degrade IR dyes, they are expensive and it not economical to apply them to large volumes of seasoned (waste) developer solutions. Some of the reagents shown in TABLE I require heating for IR dye degradation. In addition, some of the compounds (for example, ammonium persulfate, ferrous chloride, and ferric chloride) are toxic to aquatic life. Hydrogen peroxide is a potential carcinogenic and mutagenic for humans. The noted toxicity data were extracted for the MSDS sheets of these compounds. Consequently, the reagents in listed TABLE I do not represent simple and economical ways to treat seasoned developer solutions containing IR dyes.

TABLE I

| Test | Reagent | Conditions | Change Noticed |
|---|---|---|---|
| 1 | Ceric ammonium nitrate | 23° C. | Dye bleached pink |
| 2 | Ammonium thiosulfate | Heat | Dye bleached pink |
| 3 | Ammonium persulfate | 23° C. | Dye bleached pink |
| 4 | Cu(I) benzoate | Heat | Dye bleached pink |
| 5 | t-Butyl hydroperoxide + | Heat | Dye bleached pink |
| | Cu(II) salts (formate) | | |
| 6 | t-Butyl peracetate | Heat | Dye bleached pink |
| | (Luperox ® 7M50) | | |
| 7 | Peracetic acid | 23° C. | Brown |
| 8 | Peracetic acid | Heat | Dye bleached pink |
| 9 | Perchloric acid | Heat | Dye bleached pink |
| 10 | Cl-Peroxy benzoic acid | 23° C. | Dye bleached pink |
| 11 | Hydrogen peroxide | Sulfuric acid, 1%, | Black |
| | | 23° C. | |
| 12 | Hydrogen peroxide | Sulfuric acid, 1%, | Dye bleached pink |
| | | Heat | |
| 13 | Hydrogen peroxide | NaOH, room | Pink precipitate |
| | | temperature | |
| 14 | N-Bromo-succinimide | 23° C. | Dye bleached pink |
| 15 | Potassium persulfate | 23° C. | Brown |
| 16 | Manganous nitrate | 23° C. | Black |
| 17 | Ferric chloride | 23° C. | Black |
| 18 | Ferrous chloride | 23° C. | Black |
| 19 | Na sulfite | Heat | Some bleaching, |
| | | | slow, incomplete |
| 20 | Sodium hydrogen sulfite | Heat | No reaction |
| 21 | Sodium metabisulfite, | Heat | No reaction |
| | Na₂S₂O₅ | | |

### Comparative Example 4

Qualitative Experiment:

A qualitative experiment was carried out as follows. A solution of 0.3% IR dye 66e in methanol was treated with a liberal amount of commercial Chlorox® bleach solution at room temperature while shaking in a mixer. Commercial Chlorox® bleach solution contains 3.6% of sodium hypochlorite. The dye solution showed a color change from green to light yellow and a yellow precipitate was formed.

Quantitative Experiment:

The amount of bleach solution needed to degrade the IR dye 66e was determined quantitatively by titration. The bleach solution was diluted to 5% of its initial strength (solution A). A dye solution of 80.4 mg of IR dye 66e in 25 ml of methanol was made (solution B). A sample (10 ml) of solution B was titrated with 4.8 ml of solution A while stirring with a magnetic stirrer. This means that 1 mg of IR dye 66e needs 0.0074625 ml of undiluted Chlorox® bleach solution to be bleached or 1 g of IR dye 66e needs 7.46 ml of Chlorox® bleach solution for degradation. The precipitate (1) was filtered and the filtrate (1) was collected. The precipitate (yellow-orange) was washed with water and dried at room temperature for 3 days. Both the filtrate (1) and the precipitate (1) were analyzed by LC-MS for residual IR dye 66e (API 365 Triple Quadrupole mass spectrometer). The HPLC equipment used was Shimadzu LC10-AD VP ternary system with an Agilent 1100 Diode Array UV/VIS detector. The column was a Thermo BDS Hypersil C18, 2.1 mm×15 cm. The flow rate was 250 μl/min and a gradient was used starting at 5% acetonitrile:isopropanol and going to 100% in 15 minutes. The water phase was a 0.01 Molar ammonium acetate buffer with the pH adjusted to 4.7 with acetic acid.

LC-MS analysis showed that filtrate (1) did not contain IR dye 66e. Precipitate (1) however, gave a signal for the IR dye 66e in the chromatogram that was corroborated by the MS spectrum. It was estimated that about 1% of the original IR dye 66e was co-precipitated with its degradation products during the addition of the Chlorox® bleach solution.

### Comparative Example 5

This example provides evidence that if IR dye degradation is not carried out to completion using the commercial Chlorox® bleach solution for various reasons such as insufficient hypochlorite concentration, poor agitation (resulting in co-precipitation), some early degradation products similar in structure to the IR dye 66e structure can be formed. These products are of unknown toxicity and thus, their discharge to the environment may be a concern.

The original bleach solution was diluted to 5% of its initial strength (solution A). A dye solution containing 80.4 mg of IR dye 66e in 25 ml of methanol was made (solution B). A sample (20 ml) of solution B was titrated with 4.8 ml of solution A while stirring with a magnetic stirrer. The green IR dye 66e solution became reddish-brown. This represents an intermediate stage of incomplete IR dye degradation. The solution liquid was evaporated in a stream of nitrogen and taken up with a few drops of methanol that were spotted on a sodium chloride disk, analyzed by FTIR, and compared to the spectrum of IR dye 66e using a Perkin Elmer Spectrum GX spectrophotometer. The C═C bands and aromatic groups were moved from 1539 cm⁻¹ (phenyl) and 1506 cm⁻¹ (phenyl conjugated to unsaturation) to a higher frequency, 1602 cm⁻¹ and 1582 cm⁻¹, respectively, suggesting that the wide conjugation was broken. The LC-MS analysis identified two products with structures C and D that represent incomplete degradation products of IR dye 66e:

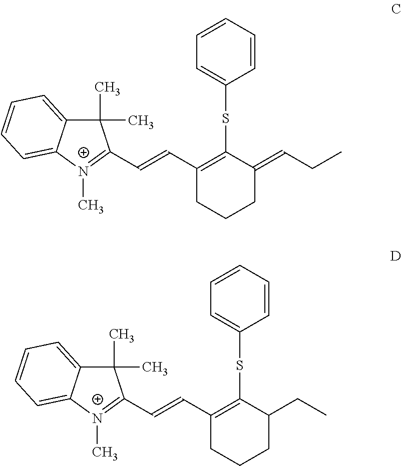

### Invention Example 1

In this example, seasoned developer solutions containing IR dye 66e were treated with commercial Chlorox® bleach solution and the degradation products were examined by LC-MS. The seasoned developer solutions were prepared in the lab after development of imaged commercially available, negative-working printing plate precursors containing IR dye 66e with Kodak 1080 Developer under conditions that account for real-life situation at the end of the processor cycle when the seasoned developer solution is being changed. The following calculation of the coating concentration in the seasoned developer solution at the end of the processing cycle takes into account that a Mercury 1035 processor will have a cycle of 3150 m² plates/9 gal (34 liters) of developer solution that is the tank capacity. If the processor is a Mercury PHD 8050 apparatus, the cycle is 900 m²-2700 m² of plates per 5 gallons (18.9 liters) of developer solution. The replenishment rate in all processors could vary between 40 ml/m² and 80 ml/m². With these data, it was calculated that at the end of a typical cycle, 11-22 m² of imaged printing plate precursors would have been processed and their coatings dissolved in 1 liter of seasoned developer solution.

To account for the lower limit, solution C was prepared by dissolving 1.1 m² of printing plate coating in 100 ml of developer solution. A sample (50 ml) of Solution C was diluted with 100 ml of water. The resulting seasoned developer solution was treated with 8 ml of Chlorox® bleach solution that was diluted to 6% of its original strength. The treatment took place under stirring at 6000 rpm and drop wise addition of diluted Chlorox® bleach solution for 10 minutes. The stirring continued for an additional 10 minutes after hypochlorite addition. A fine turbidity appeared and the particles settled out after 3 days. The precipitate was isolated, washed, and dried. The precipitate (2) and the supernatant liquid (2) were analyzed by LC-MS for the IR dye 66e using the equipment and method described above in Comparative Example 3. No trace of IR dye 66e was found in the supernatant liquid (2).

Precipitate (2) was extracted in acetonitrile:isopropanol at 2.5 mg/ml. The majority of the precipitate was not soluble. A reference sample of IR dye 66e was weighed and dissolved in acetonitrile:isopropanol and diluted to 2 ppb (2 ng/ml). This reference solution (standard) was analyzed to determine the sensitivity of the instrument. It was found that the 2 ppb standard gave better than 10:1 signal to noise response on the mass spectrometer. Using this as a working detection limit, the tested sample, which did not give a response above noise, must have had less than 500 pg/mg (or 500 ng/g) of IR dye 66e in the precipitate (2). Consequently, 0.00005% of IR dye 66e at most, was present in the precipitate (2), which is a negligible amount that can be safely discharged to the environment.

### Invention Example 2

An imageable layer coating formulation was prepared with the components in TABLE II below in a solvent mixture of methyl ethyl ketone:water:isopropyl alcohol (70:20:10 weight ratio). The formulation was coated onto a sulfuric acid anodized aluminum substrate and dried in a conveyor oven at 100° C. for 1 minute to provide an imageable layer with a dry coating weight of 1.60 g/m². The resulting printing plate precursors were imaged at 110 mJ/cm² and 11 Watt using a Kodak 3244x platesetter. The imaged precursors (approx. 11 m²) were manually developed in 1 liter of Kodak 955 Developer to produce seasoned developer solution (3).

Samples (each 50 ml) of seasoned developer solution (3) were diluted with 150 ml of water and treated with 15 ml of Chlorox® bleach solution diluted to 6% by drop wise addition while stirring at 2000 rpm. The stirring continued for another 15 minutes after the addition. The green color of the seasoned developer solution samples disappeared, forming pale yellow, slightly turbid solutions. The solutions exhibited settled light sediment (3) after about 7 days. This sediment (3) was filtered, washed, dried, and extracted overnight in methanol under stirring. The extract was concentrated about 50 times and analyzed by FTIR. The supernatant liquid was concentrated in a rotary evaporator, taken up with methanol, and then concentrated to a few drops by blowing nitrogen gas. No residual IR Dye I was found in the extract of sediment (3) or in supernatant liquid (3) providing evidence that degradation of the IR Dye I by the hypochlorite in the Chlorox® bleach solution was complete.

TABLE II

| Compound | % in dry coating |
|---|---|
| Polymer PEGMA:AN:Sty, 20:60:20* | 43.25 |
| Ebecryl ® 220 polymerizable monomer | 43.25 |
| Bis(4-t-butylphenyl)iodonium tetraphenyl | 7 |
| borate | |
| IR Dye I | 3.5 |
| Phosmer PE | 2 |
| Byk ® 333 | 1 |

*poly(ethylene glycol methacrylate-co-acrylonitrile-co-styrene)

### Invention Example 3

An imageable layer coating formulation was prepared using the components of TABLE II above except that the IR dye was S0507 from Few Chemicals GmbH. The coating formulation was prepared in a solvent mixture of MEK:water:IPA (80:10:10) and coated onto a sulfuric acid anodized aluminum substrate. The coated printing plate precursors were dried in a conveyor oven at 100° C. for 1 minute to provide a dry coating weight of 1.67 g/m². The printing plate precursors were imaged at 110 mJ/cm² and 11 Watt energy using a Kodak 3244x platesetter. Samples of these imaged precursors (about 11 m²) were developed in 1 liter of Kodak 955 Developer manually to produce seasoned developer solution (4). A sample (50 ml) of seasoned developer solution (4) was diluted with 150 ml of water. The resulting diluted seasoned developer solution was treated with 15 ml of Chlorox® bleach solution diluted to 6 weight % by addition drop wise under stirring at 1000 rpm speed. The stirring was continued for another 15 minutes after addition. The green color of the seasoned developer solution disappeared forming a pale yellow, slightly turbid solution that was filtered to give precipitate (4) and filtrate (4). This filtrate was washed with water and dried at room temperature for 3 days, and then the precipitate was extracted overnight in methanol under stirring. The extract was concentrated 50 times by evaporation under nitrogen flow and spotted onto a sodium chloride disk, dried, and analyzed by FTIR. The supernatant liquid was concentrated in a rotary evaporator and then taken up with methanol. The methanol solution was concentrated 50 times by evaporation, spotted on a sodium chloride disk, and the FTIR spectrum was taken. No residual IR dye was found in precipitate (4) or in supernatant liquid (4) proving that the degradation of the IR dye by sodium hypochlorite was complete.

### Invention Example 4

Negative-working lithographic printing plate precursors were prepared using a coating formulation having the components of TABLE III below in MEK:IPA (90:10). The coating formulation was applied to a sulfuric anodized aluminum substrate and dried in a conveyor oven at 100° C. for 80 seconds. The printing plate precursors were imaged at 110 mJ/cm² and 11 Watt energy using a Kodak 3244x platesetter. The imaged precursors (about 11 m²/liter) were developed manually in SWD1 developer (Kodak Graphics Japan) that was diluted 1 to 3 (25% of its original strength). A sample of 50 ml of the seasoned developer solution was diluted with 150 ml of water. It was then treated with 10 ml of Chlorox® bleach solution diluted to 6 weight % of its original strength its addition in a slow stream under stirring at 6000 rpm for 10 minutes. The stirring was continued for another 10 minutes after addition. The green seasoned developer solution containing S0094 IR dye became pale yellow and produced a slight colloidal precipitate that settled at the bottom after 7 days. The supernatant liquid was decanted and together with the precipitate was analyzed by FTIR as described in Invention Example 3, searching for the absorption bands characteristic to the IR dye. No IR dye could be found in the precipitate or filtrate proving that the degradation of IR dye S0094 was complete.

TABLE III

| Compound | % in dry coating |
|---|---|
| Polymer PEGMA:AN:Sty, 20:60:20* | 43.25 |
| Ebecryl ® 220 | 43.25 |
| Bis(4-t-butylphenyl)iodonium tetraphenyl | 7 |
| borate | |
| IR dye S0094 | 3.5 |
| Phosmer PE | 2 |
| Byk ® 333 | 1 |

*poly(ethylene glycol methacrylate-co-acrylonitrile-co-styrene)

The invention has been described in detail with particular reference to certain preferred embodiments thereof, but it will be understood that variations and modifications can be effected within the spirit and scope of the invention.

1. A method of treating a seasoned developer solution comprising:
adding a composition containing a hypochlorite to the seasoned developer solution containing one or more infrared radiation-sensitive cyanine dyes to decompose the cyanine dyes.

2. The method of claim 1 wherein the hypochlorite is added to the seasoned developer solution before the solution is discharged to the environment.

3. The method of claim 1 wherein the seasoned developer solution is diluted at least 5 times before addition of the hypochlorite composition.

4. The method of claim 1 wherein the hypochlorite composition is added to the seasoned developer solution in portions until the seasoned developer solution becomes colorless.

5. The method of claim 4 wherein the hypochlorite composition is added to the seasoned developer solution in a drop wise or metered fashion.

6. The method of claim 1 wherein the hypochlorite is sodium hypochlorite or potassium hypochlorite, or both.

7. The method of claim 1 wherein the seasoned developer solution is agitated during addition of the hypochlorite at a shear rate of from 10 to 20,000 rpm.

8. The method of claim 1 wherein the infrared radiation-sensitive cyanine dye is in suspended form or has a water solubility of at least 0.001% at 25° C.

9. The method of claim 1 wherein the seasoned developer solution also contains one or more unreacted free radical polymerizable or crosslinkable compounds, and non-reactive polymeric binders.

10. The method of claim 1 wherein the infrared radiation-sensitive cyanine dye is a cationic or anionic cyanine dye.

11. The method of claim 1 wherein the seasoned developer solution contains one or more of the following cyanine dyes:

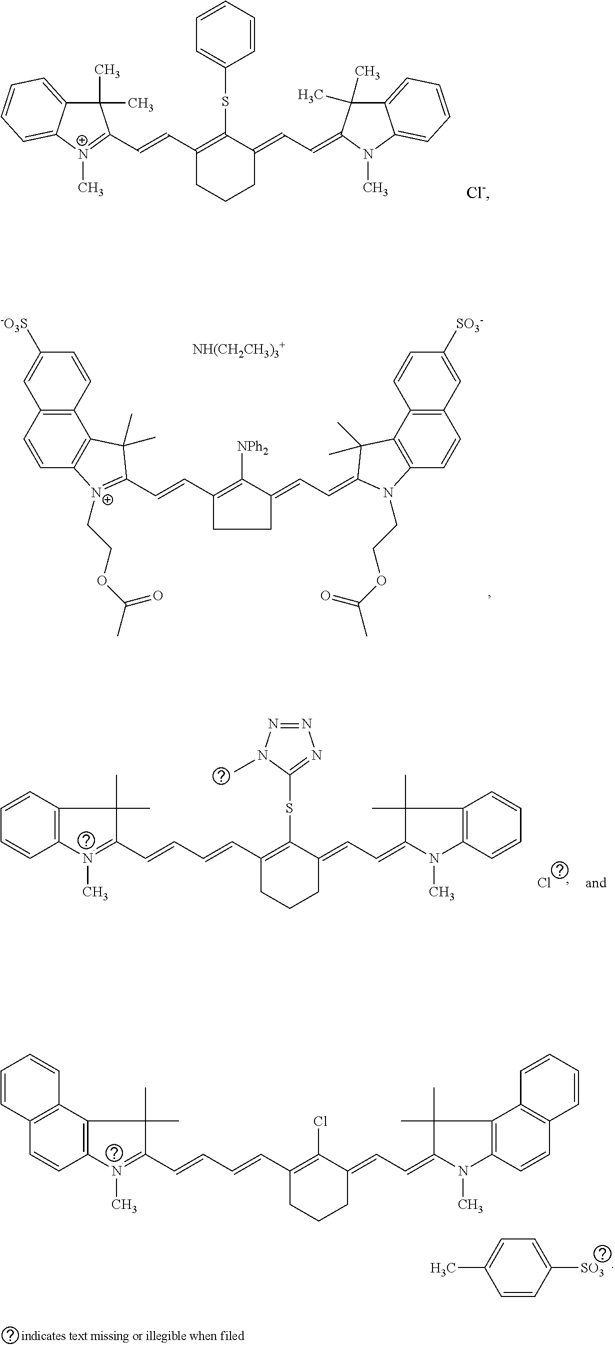

12. The method of claim 1 wherein the seasoned developer solution has a pH of at least 6 and up to and including 14.

13. The method of claim 1 wherein the seasoned developer solution contains up to 15 weight % of a water-miscible organic solvent.

14. The method of claim 1 wherein the hypochlorite composition is added to the seasoned developer solution at room temperature.

15. The method of claim 1 wherein the seasoned developer solution contains one or more non-reactive polymeric binders.
